(19) United States
(12) Patent Application Publication
(10) Pub. No.: US 2023/0409097 A1
(43) Pub. Date: Dec. 21, 2023

(54) BATTERY CHARGING CONTROL THROUGH UNIVERSAL SERIAL BUS (USB) INTERFACES

(71) Applicant: HEWLETT-PACKARD DEVELOPMENT COMPANY, L.P., Spring, TX (US)

(72) Inventors: Kartavyakumar Pravinkumar Patel, Fort Collins, CO (US); Kathleen Elizabeth Lenz, Fort Collins, CO (US); Najy Imad Faour, Fort Collins, CO (US); Peter Andrew Seiler, Fort Collins, CO (US)

(21) Appl. No.: 17/807,073

(22) Filed: Jun. 15, 2022

(51) Int. Cl. G06F 1/26; G06F 13/42

(52) U.S. Cl. CPC G06F 1/266; G06F 13/4282; G06F 2213/0042

(57) ABSTRACT

In some examples, a system includes a Universal Serial Bus (USB) interface to connect to a plurality of devices. The system includes a controller to receive battery information through the USB interface from the plurality of devices, wherein the battery information relates to batteries in respective devices of the plurality of devices, and control charging of the batteries through the USB interface using the battery information.

### BACKGROUND

Some electronic devices include batteries that can power components of the electronic devices when the electronic devices are not plugged into an external power source, such as a wall power outlet, a battery pack, another electronic device, or another type of external power source. Over time, if the battery of an electronic device is not charged, the battery can be depleted with use of the electronic device.

### BRIEF DESCRIPTION OF THE DRAWINGS

Some implementations of the present disclosure are described with respect to the following figures.

FIG. 1 is a block diagram of an arrangement that includes a source device and target devices, where the source device is able to charge batteries of the target devices, in accordance with some examples.

FIG. 2 is a block diagram of a system according to some examples.

FIG. 3 is a block diagram of a storage medium storing machine-readable instructions according to some examples.

FIG. 4 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

An example of an interface of an electronic device is a Universal Serial Bus (USB) interface. The USB interface can include a port (or multiple ports) to connect to external devices. A specific type of USB interface is a USB-C interface. Another type of USB interface is a USB4 interface.

A USB-C port can include a connector with a specific arrangement of pins defined according to a USB-C Specification. The arrangement of pins of the USB-C port includes data pins to communicate data, power pins to deliver or receive power, and other pins.

As used here, “USB” can refer to any of various versions of USB Specifications, including USB-C, USB4, and so forth. A USB interface refers to a communication interface that is able to communicate according to a USB protocol as defined by any of various USB Specifications.

In addition to communication of data, a USB interface can also be used to deliver power from a source device (which is to supply power) to a target device (which is to receive power). In some cases, the power delivered by the source device to the target device can be used to charge a battery of the target device.

The source device can include a power source that can be in the form of a battery or a power adapter that receives power from an external power source such as a wall power outlet, an external battery pack, another electronic device, and so forth. Examples of electronic devices that can behave as source devices include any or some combination of a desktop computer, a notebook computer, a tablet computer, a server computer, a display device, a smartphone, a docking station, a power charging hub, a communication node, a storage system, a vehicle, an aircraft, a ship, a home appliance, a television, or any other electronic device.

Examples of electronic devices that can behave as target devices can include any of the foregoing, as well as peripheral devices such as a removable storage device, a user input device, a speaker, a microphone, and so forth.

In some examples, a source device can perform a power negotiation with a target device according to a USB Power Delivery protocol. With the USB Power Delivery protocol, the source device can negotiate with a target device regarding the amount of charge (e.g., in terms of voltage level and electrical current) that the source device is to deliver to the target device. In some examples, the roles of the source device and the target device can be swapped based on a further USB Power Delivery negotiation, such that the target device becomes a source device and the source device becomes a target device.

In some cases, a source device can connect to multiple target devices through the USB interface of the source device. As each respective target device is connected to the source device, the source device can perform a USB Power Delivery negotiation with the respective target device to supply a certain amount of charge from the source device to the respective target device. In such examples, due to restrictions in how much power the source device can supply, a larger amount of power may be supplied by the source device to earlier connected target device(s), and a smaller amount of power or the minimum power allowed per the USB Specification may be supplied by the source device to a later connected target device since the source device may already have allocated a certain amount of power to be delivered to the earlier connected target device(s). In other instances, the total power available is split evenly between the two connected devices, lowering the power given to the earlier connected device, and decreasing the maximum power available to the later connected device.

If the later connected target device has a battery that is more depleted than the battery (or batteries) of the earlier connected target device(s), then the smaller amount of power (or the minimum power allowed per the USB Specification) supplied to the later connected target device may not be sufficient to increase the charge of the battery of the later connected target device, which may result in depletion of the battery of the later connected target device over time.

In accordance with some implementations of the present disclosure, priorities can be assigned to charging batteries of target devices connected to a USB interface of a source device based on battery information provided by the target devices to the source device through the USB interface. The charging of the batteries can then be controlled by the source device based on the battery information.

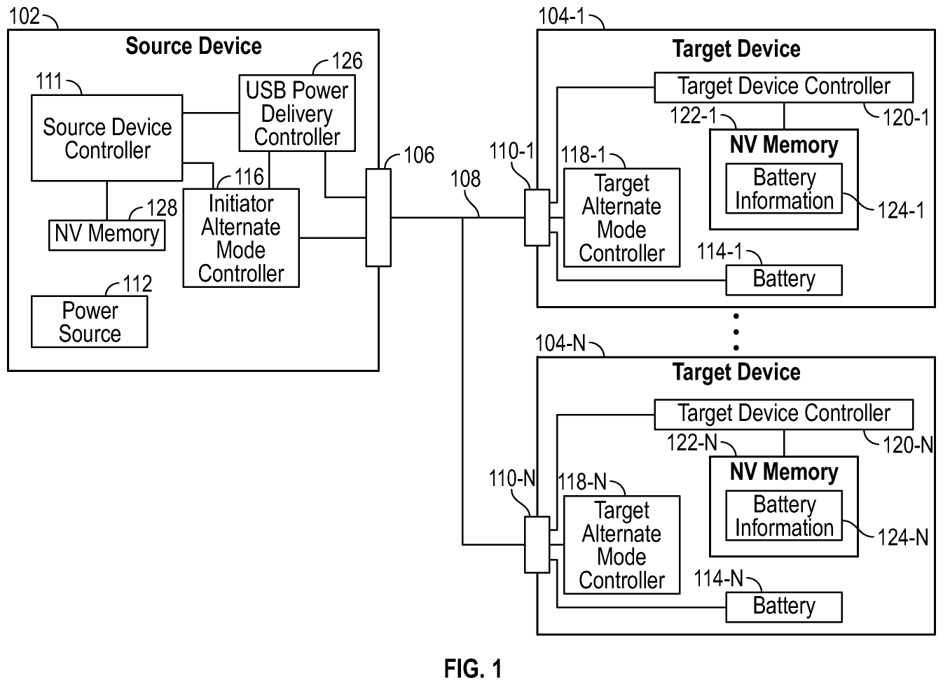

FIG. 1 is a block diagram of an arrangement that includes a source device 102 connected to multiple target devices 104-1 to 104-N, where N≥2). The source device includes a USB interface 106 to which the target devices 104-1 to 104-N can be connected over a USB connection 108. The USB interface 106 can include a single USB port or multiple USB ports.

The USB connection 108 can represent multiple USB connections between the USB interface 106 and USB ports 110-1 to 110-N of respective target devices 104-1 to 104-N. For example, a separate USB cable can be used to connect a corresponding USB port 110-i (i=1 to N) to the USB interface 106. In other examples, a USB hub can be connected to the USB interface 106 of the source device 102, where the USB hub has multiple USB ports to which the respective target devices 104-1 to 104-N can be connected over the corresponding USB connections.

The source device 102 includes a power source 112, which can include a battery and/or a power adapter that receives power from an external power source. Each of the target devices 104-1 to 144-N includes a respective battery 114-1 to 114-N.

The source device 102 includes a source device controller 111, a USB Power Delivery controller 126, and an initiator Alternate Mode controller 116. Although FIG. 1 shows three separate controllers, it is noted that functionalities of the controllers 111, 126, and 116 can be integrated into fewer controllers (e.g., a single controller, two controllers) or more than three controllers.

The term “controller” can refer to a single controller or multiple controllers. For example, a “controller” in the source device 102 can refer to any or some combination of the controllers 111, 126, and 116 (and possibly other controllers).

As used here, a “controller” can refer to a hardware processing circuit, which can include any or some combination of a microprocessor, a core of a multi-core microprocessor, a microcontroller, a programmable integrated circuit, a programmable gate array, or another hardware processing circuit. Alternatively, a “controller” can refer to a combination of a hardware processing circuit and machine-readable instructions (software and/or firmware) executable on the hardware processing circuit.

In the ensuing discussion, reference is made to specific tasks performed by each of the controllers 111, 126, and 116. Note that the tasks can alternatively be performed by other controllers in other examples.

The controllers 111, 126, and 116 can cooperatively perform dynamic charging of the batteries 114-1 to 114-N of the target devices 104-1 to 104-N based on battery information provided from the target devices 104-1 to 104-N to the source device 102 regarding the batteries 114-1 to 114-N, using USB-C Alternate Mode communications.

USB-C Alternate Mode allows for alternate protocols such as DisplayPort, High-Definition Multimedia Interface (HDMI), Thunderbolt, a proprietary protocol, and so forth (in addition to signals associated with USB) to be communicated over a USB interface.

In accordance with some implementations of the present disclosure, the initiator Alternate Mode controller 116 can perform USB-C Alternate Mode communications with target Alternate Mode controllers 118-1 to 118-N in corresponding target devices 104-1 to 104-N over the USB connection 108. Battery information relating to the batteries 114-1 to 114-N can be transmitted by the corresponding target Alternate Mode controllers 118-1 to 118-N to the initiator Alternate Mode controller 116. For example, the target Alternate Mode controller 118-1 can transmit battery information regarding the battery 114-1 over the USB connection 108 to the initiator Alternate Mode controller 116, and the target Alternate Mode controller 118-N can transmit battery information regarding the battery 114-N over the USB connection 108 to the initiator Alternate Mode controller 116.

An “initiator” Alternate Mode controller is a controller that initiates USB-C Alternate Mode communications with another device, such as a “target” Alternate Mode controller. The battery information can be carried in messages and/or information elements defined by the USB-C Alternate Mode protocol.

Although reference is made to USB-C Alternate Mode, in other examples, the target devices 104-1 to 104-N can communicate battery information with the source device 102 using different protocols, whether standardized, open-source, or proprietary.

In some examples, USB-C Alternate Mode is enabled using a USB Power Delivery protocol handshake. Once protocol negotiation is complete, vendor-defined messages (VDMs) can be used to further define proprietary Alternate Mode communications.

A target Alternate Mode controller 118-i (i=1 to N) can obtain battery information about a battery 114-i in a respective target device 104-i. For example, the target Alternate Mode controller 118-i can request, from a target device controller 120-i, the battery information. The target device controller 120-i in a target device 104-i can collect and store battery information 124-i regarding the battery 114-i in a non-volatile memory 122-i. A non-volatile memory refers to a memory device (or multiple memory devices) that is able to maintain its data content even if power is removed from the non-volatile memory.

In response to the request of the target Alternate Mode controller 118-i, the target device controller 120-i can retrieve the battery information 124-i from the non-volatile memory 122-i and send the battery information to the target Alternate Mode controller 118-i.

In other examples, the target alternate mode controller 118-i is able to access the battery information 124-i from the non-volatile memory 122-i, without having to interact with the target device controller 120-i.

More generally, a “controller” in the target device 104-i can refer to any or some combination of the controllers in the target device 104-i, including 118-i and 120-i and possibly any other controllers. Also, although reference is made to specific tasks performed by the controllers 118-i and 120-i in the present discussion, it is noted that the tasks in the target device 104-i may be performed by other controllers in other examples.

After obtaining the battery information 124-i (such as from the target device controller 120-i or directly from the non-volatile memory 122-i), the target Alternate Mode controller 118-i can send the battery information 124-i to the initiator Alternate Mode controller 116 over the USB connection 108 using USB-C Alternate Mode communications.

Examples of the battery information 124-i can include any or some combination of the following: a current battery charge (which indicates the amount of charge remaining in the battery 114-i), a battery capacity (which indicates the maximum possible charge to which the battery can be charged), a battery chemistry (which indicates the chemistry used by the battery 114-i, such as a lithium battery, a nickel cadmium battery, etc.), a battery age (which indicates an age of the battery), a battery manufacturer (which indicates a manufacturer of the battery 114-i), and so forth.

In addition to the foregoing battery information, the target Alternate Mode controller 118-i can also collect other types of information, including power consumption information of the target device 104-i (which indicates a rate of power consumption, such as average power consumption, over some specified time interval), an identifier of the target device 104-i, and so forth.

This additional information can also be provided by the target Alternate Mode controller 118-i to the initiator Alternate Mode controller 116 using USB-C Alternate Mode communications over the USB connection 108.

The initiator Alternate Mode controller 116 can store the battery information 124-i as well as any additional information received from the respective target device 104-i in a non-volatile memory 128 of the source device 102. Such information can be used by the initiator Alternate Mode controller 116 to control charging of the respective batteries 114-1 to 114-N in the target devices 104-1 to 104-N.

The initiator Alternate Mode controller 116 can store the battery information 124-i and the additional information received from the respective target device 104-i in the non-volatile memory 128 either directly or indirectly (by requesting that the source device controller 111 store the information in the non-volatile memory 128.

The non-volatile memory 128 in the source device 102 can also store power budget information that specifies how much power the power source 112 of the source device 102 can supply. The power budget information can be retrieved (either directly or indirectly through the source device controller 111) by the initiator Alternate Mode controller 116 to determine how much power can be delivered to each of the target devices 104-1 to 104-N.

Once the initiator Alternate Mode controller 116 has determined, based on the battery information and any additional information received from the target devices 104-1 to 104-N, how much power to deliver to each target device, the initiator Alternate Mode controller 116 can issue a request to the USB Power Delivery controller 126 to negotiate with each target device 104-i the amount of charge (e.g., in terms of wattage) that the source device 102 is to deliver to the target device 104-i. The negotiation can be performed between the USB Power Delivery controller 126 in the source device 102 and a USB Power Delivery controller (not shown) in the target device 104-i.

Based on negotiations with each of the target devices 104-1 to 104-N, the USB Power Delivery controller 126 in the source device 102 can control the amount of power delivered from the power source 112 through the USB interface 106 to each of the target devices 104-1 to 104-N. Note that the source device 102 may not deliver more than the minimum power defined by the USB Specification to a given target device 104-i, if the initiator Alternate Mode controller 116 determines that the given target device 104-i has a relatively low priority and the source device 102 does not have adequate power to deliver more than the minimum power to the given target device 104-i based on power delivered to other target devices from the source device 102.

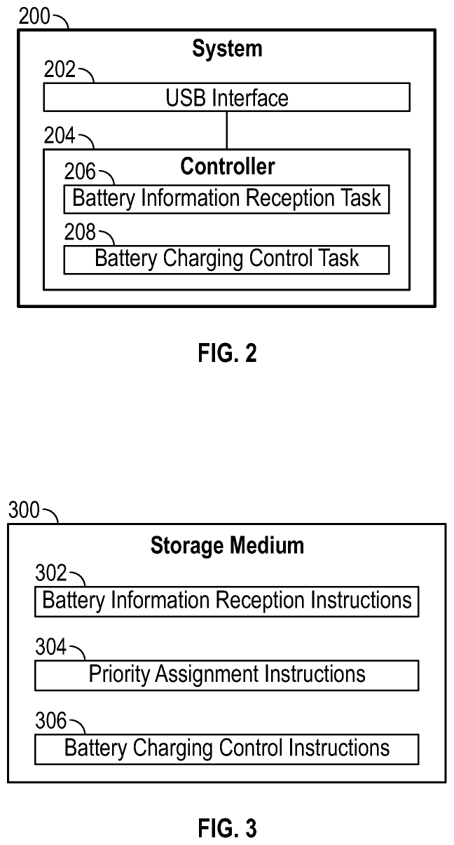

FIG. 2 is a block diagram of a system 200 (e.g., the source device 102) of FIG. 1. The system 200 includes a USB interface 202 to connect to a plurality of target devices (e.g., 104-1 to 104-N in FIG. 1).

The system 200 includes a controller 204 to perform various tasks. The controller 204 can refer to any or some combination of the controllers 111, 126, and 116 of FIG. 1, for example.

The tasks of the controller 204 include a battery information reception task 206 to receive battery information through the USB interface 202 from the plurality of target devices. The battery information relates to batteries (e.g., 114-1 to 114-N in FIG. 1) in respective target devices. In some examples, the battery information reception task 206 can be performed by the initiator Alternate Mode controller 116 of FIG. 1. In some examples, the battery information is communicated using USB-C Alternate Mode communications.

The tasks of the controller 204 include a battery charging control task 208 to control charging of the batteries through the USB interface 202 using the battery information received from the target devices. The battery charging control task 208 can be performed by the USB Power Delivery controller 126 of FIG. 1, in some examples, based on a power negotiation performed by the USB Power Delivery controller 126 with each of at least some of the target devices.

In some examples, the controller 204 determines priorities associated with charging the batteries in the target devices. For example, the determination of priorities can be performed by the initiator Alternate Mode controller 116. The controlling of the charging of the batteries is based on the determined priorities. The determined priorities include a first priority assigned to charging a first battery in a first target device, and a different second priority assigned to charging a second battery in a second target device.

In some examples, the controller 204 receives power consumption information of each target device. The controlling of the charging of the batteries through the USB interface is further based on the power consumption information. For example, if the controller 204 (e.g., the initiator Alternate Mode controller 116 of FIG. 1) determines that the target devices have different power consumptions (e.g., different power wattage consumed), then the controller 204 can determine based on the power consumption of each target device and the remaining charge of the battery of the target device how quickly the battery is expected to deplete.

As an example, the controller 204 can determine based on the power consumption and current battery charge of each target device that the battery of a first target device may deplete faster than the battery of a second target device. In such as scenario, the controller 204 can assign a higher priority to the first target device and a lower priority to the second target device, such that the source device 102 would deliver more power to the first target device than the second target device. Note at the time of assessment by the controller 204, the battery of the first target device may have a higher charge than the battery of the second target device, but because the first target device has a higher power consumption than the second target device, the controller 204 can determine that the battery of the first target device will deplete faster than the battery of the second target device.

Other factors that may influence how quickly a battery of a target device depletes can include battery age and battery chemistry. For example, an older battery may be expected to deplete more quickly than a newer battery. The battery chemistry (e.g., lithium battery, nickel cadmium battery, etc.) may also affect how quickly a battery depletes.

The controller 204 may also assess how quickly a battery can charge up to its full capacity, which may depend upon the battery age and/or battery chemistry. A battery that takes longer to charge up may be given higher priority than a battery that can be charged more quickly, for example.

Other information regarding a battery may also affect how quickly the battery depletes or how long the battery takes to charge, such as a manufacturer of the battery, and so forth.

FIG. 3 is a block diagram of a non-transitory machine-readable or computer-readable storage medium 300 storing machine-readable instructions that upon execution cause a controller (e.g., any or some combination of the controllers discussed above) in a system (e.g., the source device 102 of FIG. 1) to perform various tasks.

The machine-readable instructions include battery information reception instructions 302 to receive battery information through a USB interface from a plurality of target devices connected to the USB interface. The battery information relates to batteries in respective target devices.

The machine-readable instructions include priority assignment instructions 304 to assign respective priorities to charging of the batteries in the respective target devices.

The machine-readable instructions include battery charging control instructions 306 to control charging of the batteries in the respective target devices through the USB interface using the assigned respective priorities.

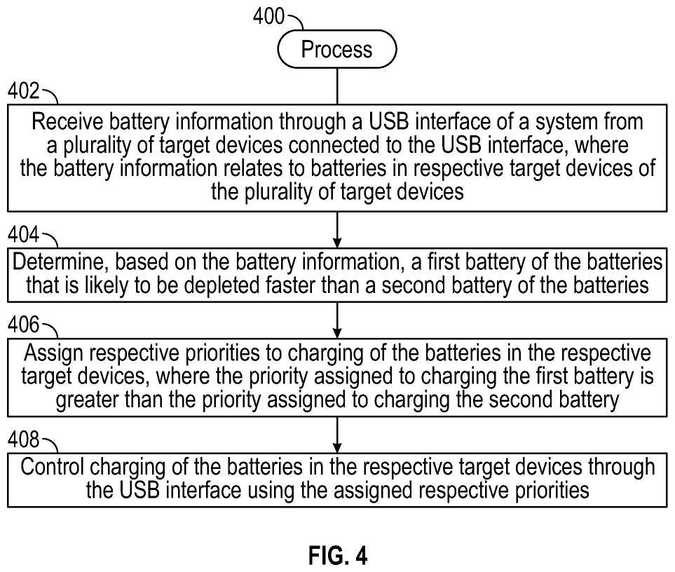

FIG. 4 is a flow diagram of a process 400, which may be performed by the source device 102, for example.

The process 400 includes receiving (at 402) battery information through a USB interface of a system from a plurality of target devices connected to the USB interface, where the battery information relates to batteries in respective target devices of the plurality of target devices.

The process 400 includes determining (at 404), based on the battery information, a first battery of the batteries that is likely to be depleted faster than a second battery of the batteries.

The process 400 includes assigning (at 406) respective priorities to charging of the batteries in the respective target devices, where the priority assigned to charging the first battery is greater than the priority assigned to charging the second battery.

The process 400 includes controlling (at 408) charging of the batteries in the respective target devices through the USB interface using the assigned respective priorities.

A storage medium (e.g. 300 in FIG. 3) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory or other type of non-volatile memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A source device comprising:
a Universal Serial Bus (USB) interface to connect to a plurality of target devices, wherein the plurality of target devices comprises a first target device and a second target device; and
a controller to:
receive first battery information through the USB interface from the first target device, wherein the first battery information comprises one or more attributes of a first battery in the first target device;
receive second battery information through the USB interface from the second target device, wherein the second battery information comprises one or more attributes of a second battery in the second target device; and
control charging of the first battery and the second battery through the USB interface based on the first battery information and the second battery information by:
determining, based on the first battery information and the second battery information, that a depletion time of the first battery is earlier than a depletion time of the second battery; and
prioritizing charging of the first battery over charging of the second battery in response to determining that the depletion time of the first battery is earlier than the depletion time of the second battery.

2. The source device of claim 1, wherein the USB interface comprises a USB-C interface, and the first battery information is received through the USB-C interface.

3. The source device of claim 2, wherein the first battery information is communicated using an Alternate Mode of the USB-C interface.

4. (canceled)

5. The source device of claim 3, wherein the first battery information comprises one or more of: a current battery charge of the first battery a battery capacity of the first battery, a battery chemistry of the first battery, or an age of the first battery.

6. The source device of claim 3, wherein the first battery information is selected from among a battery capacity of the first battery, a battery chemistry of the first battery, an age of the first battery, or a manufacturer of the first battery.

7. The source device of claim 1, wherein the controller is to:
receive a first power consumption information of the first target device; and
receive a second power consumption information of the second target device,
wherein the controlling of the charging of the first battery and the second battery through the USB interface is further based on the first power consumption information and the second power consumption information.

8. The source device of claim 7, wherein the controller is to:
determine, based on the first battery information, the second battery information, the first power consumption information, and the second power consumption information, that the depletion time of the first battery is earlier than the depletion time of the second battery.

9. The source device of claim 1, wherein the controlling of the charging of the first battery and the second battery through the USB interface is based on power negotiation according to a USB Power Delivery protocol performed by a USB Power Delivery controller.

10. A non-transitory machine-readable storage medium comprising instructions that upon execution cause a controller in a source device to:
receive first battery information through a Universal Serial Bus (USB) interface from a first target device of a plurality of target devices connected to the USB interface, wherein the first battery information comprises one or more attributes of a first battery in the first target device;
receive second battery information through the USB interface from a second target device of the plurality of target devices connected to the USB interface, wherein the second battery information comprises one or more attributes of a second battery in the second target device; and
control charging of the first battery and the second battery through the USB interface based on the first battery information and the second battery information by:
determining, based on the first battery information and the second battery information, that a depletion time of the first battery is earlier than a depletion time of the second battery; and
prioritizing charging of the first battery over charging of the second battery in response to determining that the depletion time of the first battery is earlier than the depletion time of the second battery.

11. The non-transitory machine-readable storage medium of claim 10, wherein the USB interface is a USB-C interface, and the receiving of the first battery information uses an Alternate Mode of the USB-C interface.

12. (canceled)

13. The non-transitory machine-readable storage medium of claim 10, wherein the instructions upon execution cause the controller to:
receive a first power consumption information of the first target device; and
receive a second power consumption information of the second target device,
wherein the controlling of the charging of the first battery and the second battery through the USB interface is further based on the first power consumption information and the second power consumption information.

14. A method comprising:
receiving, by a controller in a source device, first battery information through a Universal Serial Bus (USB) interface of the source device from a first target device of a plurality of target devices connected to the USB interface, wherein the first battery information comprises one or more attributes of a first battery in the first target device;
receiving, by the controller in the source device, second battery information through the USB interface of the source device from a second target device of the plurality of target devices connected to the USB interface, wherein the second battery information comprises one or more attributes of a second battery in the second target device;
determining, by the controller based on the first battery information and the second battery information, that a depletion time of first battery is earlier than a depletion time of the second battery;
assigning, by the controller, respective priorities to charging of the first battery and the second battery, wherein the priority assigned to charging the first battery is greater than the priority assigned to charging the second battery; and
controlling charging of the first battery and the second battery through the USB interface based on the assigned respective priorities.

15. The method of claim 14 wherein the first battery information is selected from among a current charge of the first battery, a battery capacity of the first battery, a battery chemistry of the first battery, an age of the first battery, and a manufacturer of the first battery.

16. The source device of claim 1, wherein the depletion time of the first battery comprises an expected depletion time of the first battery and the depletion time of the second battery comprises an expected depletion time of the second battery.
